(19) United States
(12) Patent Application Publication
(10) Pub. No.: US 2016/0316619 A1
(43) Pub. Date: Nov. 3, 2016

(54) HEIGHT OF CUT CONTROL SYSTEM

(71) Applicant: Deere & Company, Moline, IL (US)

(72) Inventors: Scott M. Johanek, Augusta, GA (US); John P. Kruckeberg, Thomson, GA (US); Michael J. Boynton, Augusta, GA (US); Shayne A. Ralston, Cary, NC (US)

(21) Appl. No.: 14/702,454

(22) Filed: May 1, 2015

(51) Int. Cl. A01D 34/00; A01D 34/81

(52) U.S. Cl. CPC A01D 34/008; A01D 34/81; A01D 2101/00

(57) ABSTRACT

A height of cut control system on a mower deck includes a linear actuator connected to the lift linkage. A height of cut dial has a plurality of operator-selected desired cutting heights, and a deck height control is connected to the electronic controller that commands the linear actuator to lower or raise the mower deck to the desired cutting height when the deck height control is in a down position or an up position. A deck height display provides visual feedback to the operator showing if the actual height of the mower deck is off the desired cutting height. If the actual height is at least a specified amount off the desired cutting height, the electronic controller may automatically adjust the mower deck by commanding the linear actuator to move the mower deck to the desired cutting height.

### FIELD OF THE INVENTION

This invention relates generally to height adjustable mower cutting decks, and specifically to a height of cut control system for a mower deck.

### BACKGROUND OF THE INVENTION

Vegetation cutting implements known as mower cutting decks are typically carried by compact utility tractors, other utility vehicles, lawn and garden tractors or zero turn mowers. These vehicles have mower deck lift linkages allowing adjustment of the decks between a range of heights above ground level. Ordinarily, the range extends between a position at or below the lowest available cutting height to a position at or above the highest available cut height. Adjustment to a position below the cutting height range is frequently preferred for ease in installation or removal of the deck from the vehicle because the deck is at or very close to the ground surface. Adjustment above the cut height range may permit the deck to clear obstacles encountered while traveling across the ground. This maximum height may be referred to as the deck transport position.

Adjustment of the cutting deck height may be accomplished by various mechanisms including hand-operated levers and bars positioned in the vicinity of the tractor's or mower's operator station. The height of cut control systems require an operator to either push or pull on a lever or bar to adjust the deck height. Pedal actuated mechanisms also are used to adjust cutting deck height relative to the vehicle frame, and may include a handle or other hardware which automatically locks the mower deck in a given position upon full actuation of the pedal.

Examples of height of cut control systems for mower decks include U.S. Pat. No. 4,120,136 for “Implement Supporting and Lifting Linkage”; U.S. Pat. No. 5,138,825 for “Riding Mower Having a Pedal Operated Height Adjustment Mechanism, Air Assisted Discharge, and Improved Hydrostatic Shift Linkage”; U.S. Pat. No. 5,187,925 for “Mower Deck Lift System Handle Mechanism”; U.S. Pat. No. 5,351,467 for “Height Adjustment Mechanism for Riding Mower Cutting Deck”; U.S. Pat. No. 5,381,648 for “Mower Deck Height Adjustment Mechanism”; U.S. Pat. No. 5,797,252 for “Height of Cut Adjustment Mechanism”; U.S. Pat. No. 5,816,033 for “Riding Lawn Mower Including a Mower Deck Height Control Mechanism”; U.S. Pat. No. 5,946,893 for “Lawn Mower Having Cutter Deck Motion Coupled to Mower Wheel Motion”; U.S. Pat. No. 6,427,430 for “Pedal Lift System for Lawn Tractor Mower Deck”; U.S. Pat. No. 6,494,028 for “Deck Lift Apparatus for Riding Mower”; U.S. Pat. No. 6,588,188 for “Foot Lift Cutter Deck Mower Units”; U.S. Pat. No. 6,837,032 for “Pedal Actuated Height Adjustment Mechanism for a Mower Cutting Deck”; U.S. Pat. Nos. 7,448,191 and 7,614,207 for “Mower Deck Lift System with Transport Lock”; and U.S. Pat. No. 7,716,906 for “Single Lever Mower Deck Height-Of-Cut Control.”

Height of cut control systems with linear actuators have been proposed for mower decks. For example, patents describing linear actuators include U.S. Pat. No. 3,948,024 for “Implement Position Control System”; U.S. Pat. No. 4,663,923 for Self-Propelled Mower”; Japanese Application No. JP-H1-174307A; Japanese Application No. JP-H1-179616A; Japanese Application No. JP-H10-42654A; Japanese Application No. JP-H5-260838A; and U.S. Pat. No. 7,146,786 for “Electric Linear Deck Lift Assembly”. These height of cut control systems include linear drive rods, positional sensors and/or linear potentiometers to move mower decks to desired cutting heights. However, mower decks have a tendency to shift away from desired cutting heights due to wear over time or impacts with objects. As a result, height of cut control systems may lose accuracy of cutting height during normal use. A height of cut control system is needed that can adjust or return a mower deck to the desired cutting height while mowing. A height of cut control system also is needed that provides visual feedback to the operator showing if the actual height of the mower deck is off the desired cutting height.

In the past, height of cut control systems have required raising the mower deck off a stop before changing the desired cutting height. A height of cut control system is needed that allows an operator to move the mower deck to various different cutting heights while continuing to mow.

### SUMMARY OF THE INVENTION

A height of cut control system on a mower deck includes a linear actuator connected to the lift linkage. A height of cut dial has a plurality of operator-selected desired cutting heights, and a deck height control connected to the electronic controller that commands the linear actuator to lower or raise the mower deck to the desired cutting height when the deck height control is in a down position or an up position. The height of cut control system allows an operator to move the mower deck to various different cutting heights while continuing to mow.

A potentiometer connected to the electronic controller may provide signals indicating the actual height of the mower deck. A deck height display provides visual feedback to the operator showing if the actual height of the mower deck is off the desired cutting height. If the actual height is at least a specified amount off the desired cutting height, the electronic controller may automatically adjust the mower deck by commanding the linear actuator to move the mower deck to the desired cutting height.

### BRIEF DESCRIPTION OF THE DRAWINGS

FIG. 1 is a perspective view of a compact utility tractor with a height of cut control system according to one embodiment of the invention.

FIG. 2 is a perspective view of a height of cut control system according to one embodiment of the invention.

FIG. 3 is a perspective view of an operator station of a height of cut control system according to one embodiment of the invention.

### DESCRIPTION OF THE PREFERRED EMBODIMENT

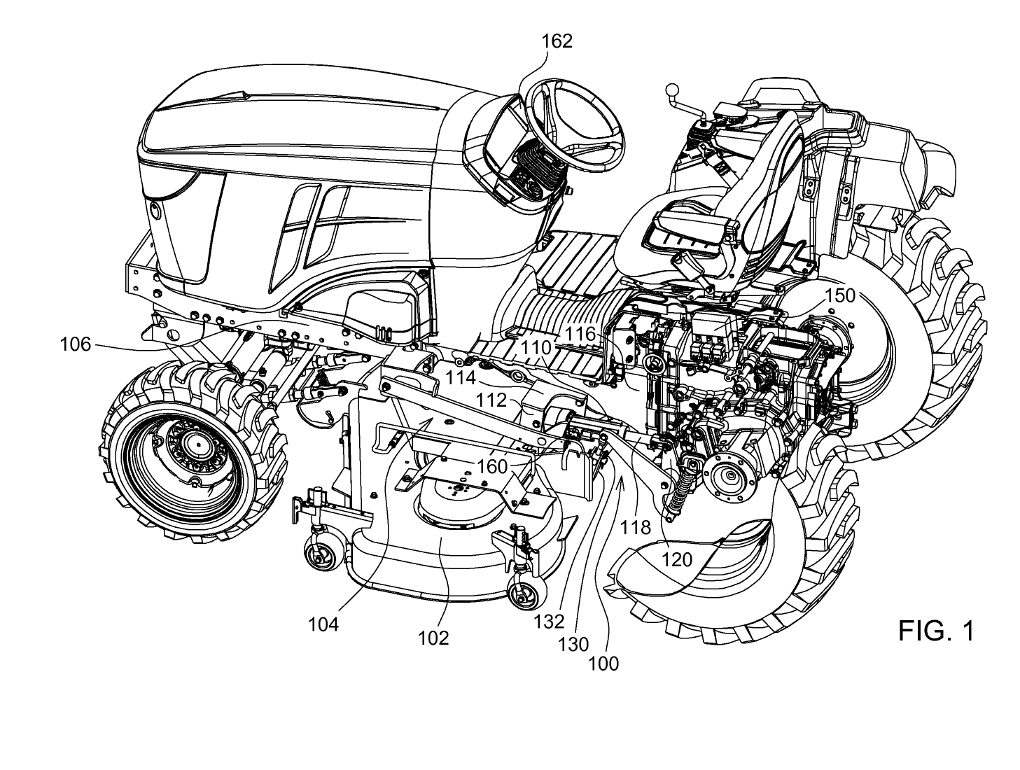

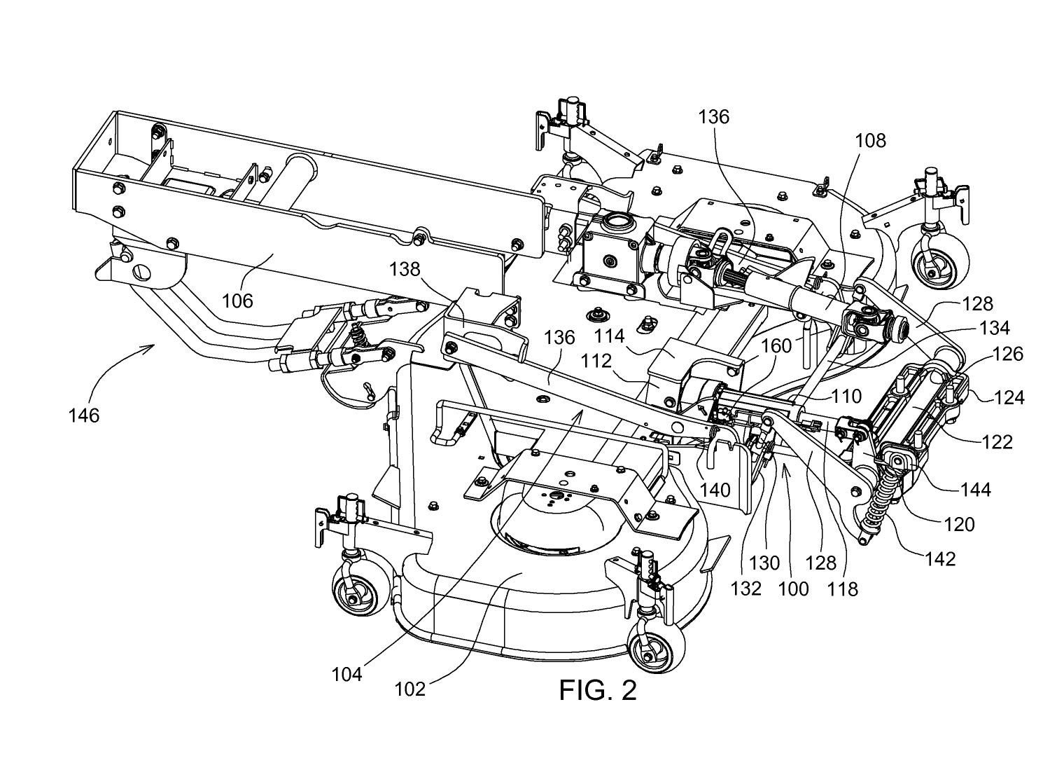

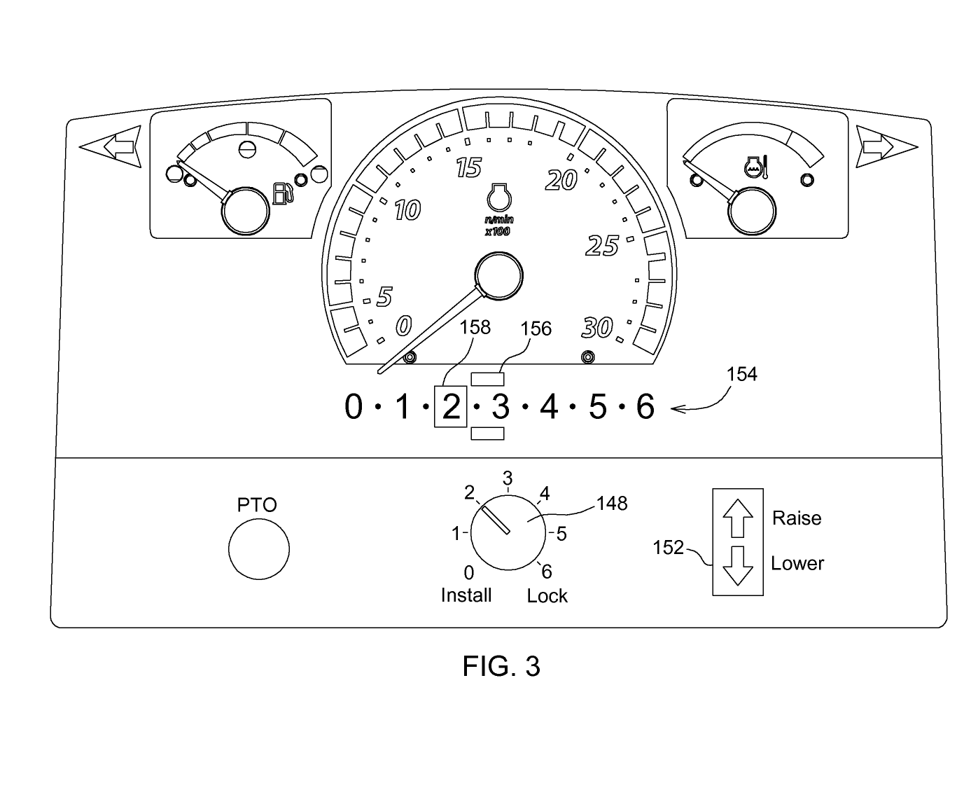

In a first embodiment shown in FIGS. 1-3, height of cut control system 100 may be installed with mower deck 102 having mower deck rear lift linkage 104 having a forward end mounted to and/or suspended under vehicle frame 106 between the front and rear wheels of a compact utility tractor or other utility vehicle, lawn and garden tractor or zero turn mower. The mower deck may receive power from an engine or other power source through PTO shaft 108, belts and pulleys, or a gearbox.

In one embodiment, height of cut control system 100 may include linear actuator 110 connected to rear lift linkage 104 and powered by electric motor 112. The linear actuator may be mounted with actuator mount 114 to transmission housing 116 or the vehicle frame. The linear actuator may be capable of actuating against compressive and tension forces of up to about 7000 N at a speed of about 20 mm/second. Piston travel of the actuator may be sufficient to provide movement of the mower deck from the lowest or install position to the highest or lock position. For example, a stroke length of about 4 inches may be sufficient to lower and raise the mower deck to each height within the described height range. The linear actuator also should be capable of reliable operation in adverse mowing conditions including vibration, high temperatures, dust and moisture. The linear actuator may include rod 118 extending rearwardly and that may be pivotably connected with a pin to actuator bell crank 120. The actuator bell crank may be attached to mower rockshaft 122. Rockshaft support 124 may be mounted transversely across and under the rear axle housing or vehicle frame and may include bushings 126 that pivotably support the mower rockshaft. Deck lift bell cranks 128 may be mounted to the opposing ends of the mower rockshaft. The mower deck rear lift linkage may include lift links 130 suspended from each deck lift bell crank, and hangers 132 that may connect the lift links to cross rod 134. The rear lift linkage also may include draft arms 136 mounted to each opposing end of the cross rod. Each draft arm may have a forward end pivotably mounted to a support 138 attached to the vehicle frame, and a rearward end with a fork 140 that engages a rear draft mower support on the mower deck.

In one embodiment, height of cut control system 100 may include deck lift assist spring 142 which may include a coil spring and shock absorber connected together between a lower portion of deck lift bell crank 128 and bracket 144 attached to rockshaft support 124. The deck lift assist spring may be compressed as the mower deck is lowered and provide additional force to help raise the mower deck. The spring compression force may be based on the weight of the mower deck, and should provide sufficient force to assist the linear actuator in lifting the mower deck from the lowest position to the highest position.

In one embodiment, the mower deck also may be supported by front draft pivot assembly 146 connecting the front of the mower deck to a front portion of the compact utility tractor frame 106.

In one embodiment, height of cut control system 100 may include deck height dial 148 connected to electronic controller 150. The deck height dial may have various desired cutting height settings that an operator may select, such as 1 inch up to 6 inches, an install position, and a locked position for transport.

In one embodiment, height of cut control system 100 may include deck height control 152 connected to controller 150. The deck height control may be a lever, button or switch, that an operator may use to move the mower deck up or down to the setting on the deck height dial. For example, if the operator sets the deck height dial to a desired cutting height, he or she may push and hold the deck height lever forward (or actuate a lower button or switch) to signal the electronic controller to command the linear actuator to lower the mower deck to the desired cutting height. If the operator sets the deck height dial to the locked position, the operator may pull back and hold the deck height lever rearward (or actuate a raise button or switch) to signal the electronic controller to command the linear actuator to fully raise the mower deck to a locked position for transport. If the operator sets the deck height dial to the install position, the operator may push and hold the deck height lever forward (or actuate the lower button or switch) to signal the electronic controller to command the linear actuator to lower the mower deck to the ground for installation or removal.

In one embodiment, height of cut control system 100 may include deck height display 154 that provides continuous visual feedback to the operator of the actual height of the mower deck. The deck height display also may show the actual height 156 compared to the desired cutting height 158. For example, potentiometer 160 on linear actuator 110 may provide electronic signals indicating actual deck height to electronic controller 150, and deck height dial 148 may provide electronic signals of the desired cutting height to the electronic controller. The electronic controller may show both on the display while mowing. The deck height dial, deck height control and deck height display may be located in or next to the operator station 162 of the tractor or other vehicle, so the operator may see the actual height and/or desired cutting height, and adjust the actual height and/or desired cutting height while mowing.

In one embodiment, height of cut control system 100 may automatically adjust the actual height of the mower deck while mowing. Electronic controller 150 may receive electronic signals from potentiometer 160 and deck height dial 148 indicating if the actual height is the same as the desired cutting height, or how much the actual height may be off the desired cutting height. If the electronic controller determines the actual height of the mower deck is at least a specified amount such as ¼ inch off the desired cutting height, the controller may automatically adjust the mower deck by commanding linear actuator 110 to raise or lower the mower deck until the potentiometer shows the actual height of the mower deck is at the desired cutting height.

Having described a preferred embodiment, it will become apparent that various modifications can be made without departing from the scope of the invention as defined in the accompanying claims.

1. A height of cut control system, comprising:
a mower deck having a lift linkage;
a linear actuator connected to the lift linkage and to an electronic controller;
a height of cut dial connected to the electronic controller and having a plurality of operator-selected desired cutting heights;
a deck height control connected to the electronic controller that commands the linear actuator to lower or raise the mower deck to the desired cutting height when the deck height control is in a down position or an up position;
a potentiometer connected to the electronic controller and providing signals indicating the actual height of the mower deck; and
a deck height display connected to the electronic controller and showing the actual height and the desired cutting height.

2. The height of cut control system of claim 1 further comprising a deck lift assist spring connected to the lift linkage and urging the lift linkage to raise the mower deck.

3. The height of cut control system of claim 1 wherein the height of cut dial includes an install position below the desired cutting heights and a locked position above the desired cutting heights.

4. The height of cut control system of claim 1 wherein the linear actuator includes a rod extending rearwardly and connected to an actuator bell crank.

5. The height of cut control system of claim 1 wherein the deck height display is in an operator station and provides continuous visual feedback.

6. A height of cut control system, comprising:
a mower deck having a lift linkage;
an electronic controller commanding a linear actuator connected to the lift linkage;
the electronic controller determining how far off an actual height of the mower deck is from a desired cutting height; and if the actual height is at least a specified amount off the desired cutting height, the electronic controller automatically adjusts the mower deck by commanding the linear actuator to move the mower deck to the desired cutting height.

7. The height of cut control system of claim 6 further comprising a visual display showing the actual height of the mower deck compared to the desired cutting height.

8. The height of cut control system of claim 6 further comprising a deck height dial that may be used to set the desired cutting height.

9. The height of cut control system of claim 8 further comprising a deck height lever causing the linear actuator to move the mower deck to the desired cutting height of the deck height dial.

10. A height of cut control system, comprising:
an actuator bell crank attached to a mower rockshaft of a lift linkage supporting a mower deck;
a linear actuator connected to the actuator bell crank;
a deck height dial connected to an electronic controller that commands the linear actuator to raise or lower the mower deck to a desired cutting height on the deck height dial; and
a deck height display connected to the electronic controller and showing the actual deck height compared to the desired cutting height.

11. The height of cut control system of claim 10 further comprising a deck lift assist spring connected to the mower rockshaft and urging the mower rockshaft to rotate in a direction to raise the mower deck.

12. The height of cut control system of claim 10 further comprising a deck height control that may be actuated to cause the electronic controller to command the linear actuator to raise or lower the mower deck to the desired cutting height.

13. The height of cut control system of claim 10 wherein the electronic controller commands the linear actuator to raise or lower the mower deck to the desired cutting height if the actual height is off a specified amount from the desired cutting height.
